(19) United States
(12) Patent Application Publication
(10) Pub. No.: US 2025/0306609 A1
(43) Pub. Date: Oct. 2, 2025

(54) SAFETY SYSTEM ASSEMBLY FOR MONITORING A ZONE AND A METHOD OF MONITORING SUCH A ZONE

(71) Applicant: SICK AG, Waldkirch (DE)

(72) Inventors: Markus HAMMES, Freiburg (DE); Jörg SIGMUND, Kenzingen (DE); Nikolaus MAYER, Freiburg (DE); Angelina MÜLLER, Freiburg (DE)

(21) Appl. No.: 19/090,277

(22) Filed: Mar. 25, 2025

(30) Foreign Application Priority Data
Mar. 26, 2024 (EP) 24166193.3

(51) Int. Cl. G05D 1/693; G05D 1/65; G05D 101/10; G05D 107/70

(52) U.S. Cl. CPC G05D 1/693; G05D 1/65; G05D 2101/10; G05D 2107/70

(57) ABSTRACT

A safety system assembly (1) serves to monitor a zone (5), such as a warehouse or a factory, in which objects (8), such as autonomously driving vehicles (4) and persons (8a), move together. The safety system assembly (1) comprises a central processing device (3) that is configured to receive sensor data (6) from a plurality of monitoring units (2), in which sensor data (6) the objects (8) detected in the monitored zone (5) by the monitoring units (2) are included. The central processing device (3) is configured to consolidate the received sensor data (6). The central processing device (3) is configured to create object lists (7) from the consolidated sensor data, with the object lists (7) including the detected objects (8) together with the respective object information, and to transmit these object lists (7) to the autonomously driving vehicles (4).

The invention relates to a safety system assembly for monitoring a zone and to a method of monitoring such a zone.

Autonomously driving vehicles, in particular in the form of forklift trucks, which can be used in warehouses or logistics centers, have the potential to improve the efficiency and safety of the processes in such warehouses. These autonomously driving vehicles are programmed to transport, stack and sort goods and materials independently without the need for human drivers.

The autonomously driving vehicles can be used differently in this respect. There are zones in which only autonomously driving vehicles are used and zones which are also entered by humans during a normal operating sequence, whereby a mixed operation results. In these highly dynamic environments, humans and machines move in confined spaces, perform a variety of tasks, from goods receipt to storage and dispatch. An efficient and safe integration of these autonomously driving vehicles into these environments requires advanced sensors and algorithms for recognizing and interpreting the environment. As a result, collisions can be avoided and a smooth operating sequence can be ensured.

To prevent accidents, encapsulated safety components of low complexity are used in industrial environments. The usual safety chain in an autonomously driving vehicle comprising a safety sensor, a safety controller and a safe actuator predominantly uses certified safety components with fixed functions, a defined safety level, a clearly described intended use and defined interfaces. The use of a sensor and the logic of hazard avoidance is already defined in these systems during commissioning and remains unchanged during operation. However, minor dynamic modifications to the safety function are possible, for example in the form of field switching or muting functions. Overall, however, it must be said that the safety technology to date is static. This means that in the event that the obtained sensor data are consistent, the safety function (e.g. a protective field monitoring) is executed as planned. If the system detects deficits in the sensor data and inconsistencies in the expected sequence, a safe state is assumed and an intervention from the outside is required. In this case, the autonomously driving vehicle is usually brought to a complete stop. In this sense, the known safety technology is therefore very rigid and is adapted for avoiding complexity by the strict encapsulation and the use of certified safety components with a defined function.

Such a design has proven itself over decades through its simplicity and the modular design. With increasingly complex automation sequences, the simple safety solutions are often no longer sufficient. The very local orientation of the safeguarding (only at the hazard area itself), the low information content of the sensor data and the lack of flexibility with respect to changing process conditions and fault scenarios set limits to this classic approach. In particular, the lack of resilience with respect to defect cases and inconsistencies or poor sensor data severely limits the productivity of such autonomously driving vehicles. With such autonomously driving vehicles, the limitation of the safety-related use is determined by the risk class of the components. It is thus not possible to hedge risks of a higher risk class by dynamically adding further independent safety information.

It is therefore the object of the present invention to provide a possibility that allows the safeguarding of complex automation processes in a wide-ranging operating environment for a plurality of hazard scenarios. In this respect, it should be possible by means of this invention to react dynamically and adapted to changing situations. In particular, it should be possible to maintain the safe operation of the automation processes if errors, inconsistencies or poor quality affect the sensor data used.

The object is satisfied by the safety system assembly for monitoring a zone according to claim 1 and by the corresponding method of monitoring this zone according to claim 15. Advantageous further developments of the safety system assembly are specified in claims 2 to 14.

The safety system assembly serves to monitor a zone, such as a warehouse or a factory, in which objects, such as autonomously driving vehicles and persons, move together. The safety system assembly comprises a central processing device that is configured to receive sensor data from a plurality of monitoring units, in which sensor data the objects detected in the monitored zone by the monitoring units are included. The central processing device is configured to consolidate, i.e. merge, the sensor data received. The central processing device is further configured to create object lists from the consolidated sensor data, with the object lists including the detected objects together with the respective object information. The central processing device is furthermore configured to transmit these object lists to the autonomously driving vehicles.

It is particularly advantageous that a consolidation, which can also be designated as fusion, of different sensor data is performed to detect the various objects in the zone to be monitored and to characterize them accordingly. It is furthermore particularly advantageous that this information, in the form of object lists, is transmitted to the autonomously driving vehicles. In this case, the autonomously driving vehicles have additional information which they can use for a safety-related assessment of various situations. Furthermore, the information content of sensor data that can be used for safety purposes is significantly increased by using the plurality of monitoring units. This means that the autonomously driving vehicles receive information not only from the immediate vicinity of a hazard area, but also from a larger area (entire factory, warehouse, etc.) and, on the basis of this information, simultaneously achieve hazard avoidance and a productivity increase for many hazard areas.

An object list is preferably created for each object that can be a person, a stationary object, such as a pallet, or an autonomously driving vehicle. Each object list contains at least one piece of object information.

A separation between the rigid connection of data acquisition and processing, such as filtering, on the one hand, and the use of the data, on the other hand, in particular takes place in the safety system assembly according to the invention. The safety chain thus becomes more flexible and allows the dynamic integration of sensor data depending on availability and suitability, on the one hand, and the dynamic use of the object information in different functions, in particular within the autonomously driving vehicles, on the other hand. By using this object information, which the safety systems of the autonomously driving vehicles receive via object lists, said safety systems can react more flexibly and in a situation-adapted manner to a hazardous situation. In particular, they can, possibly by using such redundant information, switch to a productivity-preserving fallback mode if errors, poor quality or inconsistent data are detected in individual sensor sources.

The safety system assembly according to the invention therefore allows the consolidation, i.e. the fusion, of information (for example sensor data) from different sources. Higher-quality and more dynamic functions can thereby be realized than before, in particular in autonomously driving vehicles. Furthermore, a forward-looking risk avoidance can be achieved. It is also possible to provide a central information hub, in the form of the central processing device, that is formed in a cloud system, for example. Furthermore, an improvement in the productivity of the autonomous operating sequences of the autonomously driving vehicles takes place since, due to the additional information (object lists with object information), a more precise control of the autonomously driving vehicles is possible and a slow travel of these autonomously driving vehicles can thereby be reduced. In particular, the downtime of such an autonomously driving vehicle can also be reduced. The safety system assembly according to the invention also allows a linking of safety functions and automation functions as well as an integration of the corresponding data into IT/OT systems.

In a further embodiment, the object information of an object comprises a position, size, direction of movement and/or speed of movement, object ID and/or object class for the object. An object class indicates whether the object is, for example, a person, an autonomously driving vehicle or a stationary object. The object information can be extracted from the sensor data that are generated by the plurality of monitoring units. The object information can be generated over a longer time period or once. The object information is preferably continuously updated by the plurality of monitoring units. In particular, the central processing device is configured to extract the object information from the multitude of sensor data. Thus, the central monitoring unit is configured to collect the sensor data and to evaluate said sensor data, in particular with respect to their information content, i.e. the object information included in the sensor data.

In a further embodiment, the central processing device is configured to convert the sensor data of the plurality of monitoring units into a common spatial and temporal coordinate system. This is in particular a possibility of consolidating the sensor data. The common spatial and temporal coordinate system can cover the entire zone to be monitored or a partial zone.

In a further embodiment, the central processing device is configured to graphically display the common spatial and/or temporal coordinate system on an output unit, such as a screen and/or a website. Different objects can in this respect be highlighted differently, for example, by colors and/or hatching and/or symbols and/or sizes. Objects that have a confidence level below a threshold value can in particular be highlighted so that a user viewing the output unit recognizes hazardous situations.

In a further embodiment, the central processing device is configured to subject the received sensor data to a plausibility check by checking whether a respective object is included in the sensor data from at least two monitoring units whose monitoring zones at least partly overlap (spatially); and/or whether a respective moving object is included; and/or whether a respective moving object is included, in different but mutually adjoining time periods, in the sensor data from at least two monitoring units whose monitoring zones adjoin one another. If this is the case, the object can be assigned a higher confidence level than if the object is only included in sensor data from only one monitoring unit. In the latter case, a maintenance message can optionally also be issued that at least one of the monitoring units should be checked for their correct functioning. In this case, the central processing device is not only configured to collect and consolidate the multitude of sensor data from the monitoring units, but also to check the sensor data for their plausibility.

In a further embodiment, the safety system assembly comprises at least one assessment device that is configured to determine a confidence level for an object based on the sensor data and/or the object information. The assessment device is preferably arranged in the central processing device. In this case, the central processing device is not only configured to collect and consolidate the multitude of sensor data from the monitoring units, but also to evaluate the sensor data with respect to their information content and, from this, to determine a confidence level for the respective object. This confidence level is transmitted together with the object list or within the object list to the at least one autonomously driving vehicle. The autonomously driving vehicle, which receives such a confidence level for an object, is then configured to provide various safety functions based on this confidence level. Thus, the autonomously driving vehicle can stop if the confidence level of an object in its environment (within a predetermined distance range) is low or can continue travelling at an undiminished speed if the confidence level is high, even if the corresponding object is in the immediate vicinity (within a predetermined distance range) of the autonomously driving vehicle. Optionally, the assessment device can also be arranged in one or more of the autonomously driving vehicles. In this case, the object information is transmitted from the central processing device (fusion core) to the autonomously driving vehicles without a safety assessment. In principle, it is particularly advantageous that the safety system assembly also performs a safety-related assessment and classification of the detected objects.

In a further embodiment, the assessment device is configured to determine the safety level and/or the performance level based on the confidence level or based on the sensor data and/or the object information. In this respect, there are the performance levels a to e, for example. The performance levels indicate the probability of a dangerous failure per hour ((PFHd) 1/h). They are defined in the standard ISO 13849-1:2006. Reference is furthermore made to IEC61508. Additionally or alternatively, the assessment device is also configured to define the safety integrity levels SIL1 to SIL4 based on the confidence level or based on the sensor data and/or the object information.

In a further embodiment, the assessment device is configured to define a higher confidence level for an object if the object is included in sensor data from at least two monitoring units that were produced at the same time and whose monitoring fields at least partly overlap. In this case, object information such as position, size, direction of movement and speed of movement can be verified based on the sensor data of the at least two monitoring units.

In a further embodiment, the assessment device is configured to determine the confidence level for the object based on the quality of the sensor data and/or of the object information.

In a further embodiment, the quality of the sensor data depends on physical properties of the respective monitoring unit, wherein the physical properties in particular comprise the age, the type, the error rate, the failure rate, the scatter rate, the measurement method, the installation location and/or confidence information of the respective monitoring unit. If the monitoring unit is newly installed, it can be assumed that the failure rate is low. If uniform temperatures are present at the installation location and the monitoring unit is protected from precipitation, the quality is higher than if the monitoring unit is exposed to strong temperature fluctuations and precipitation. A monitoring unit whose sensor data have a good signal-to-noise ratio has a higher quality than in the case of a poorer signal-to-noise ratio. If the scatter rate of the sensor data of a monitoring unit is high, the quality is low. Additionally or alternatively, the quality of the object information depends on the position, direction of movement and/or object class. In particular, it is important whether it is a person or an autonomously driving vehicle. In the case of an autonomously driving vehicle, it can thus be assumed that the direction of movement will correspond to a specific movement profile, whereas this cannot be readily assumed for a person. The speed of movement of an autonomously driving vehicle is also more constant than the speed of movement of a person.

In a further embodiment, the higher the quality of the sensor data, the higher the confidence level.

In a further embodiment, the assessment unit comprises an AI module. The AI module is configured to determine the confidence level for an object based on the sensor data and/or the object information. Such an AI module can generally be trained using already recorded sensor data. Thus, the sensor data from a plurality of monitoring units can be fed to the AI module. It is generally conceivable that, in addition to the sensor data, the AI module could also be provided with information about which type of objects (persons, autonomously driving vehicles, stationary objects) the objects are and how the confidence level of these individual objects was assessed. Based on the movements of the classified objects, the AI module can recognize differences between a person and an autonomously driving vehicle. Based on these training data, the trained AI module can independently determine a confidence level of other objects based on other sensor data that include other monitoring data. It is also conceivable that scenarios that have led to unusual situations and/or accidents could be fed to the AI module for training.

In a further embodiment, the safety system assembly comprises at least one autonomously driving vehicle, wherein the at least one autonomously driving vehicle is configured to receive the object list from the central processing device.

In a further embodiment, the central processing device is configured to send an autonomously driving vehicle only object lists comprising those objects together with the corresponding object information that are located within a specific distance from the autonomously driving vehicle. In this case, not all the object lists that comprise all the objects in the zone to be monitored would be sent to the autonomously driving vehicle.

In a further embodiment, the at least one autonomously driving vehicle is configured to drive into an intersection zone without braking if objects on the object list whose distance from the intersection zone is smaller than a distance threshold value have a confidence level that is greater than the first threshold value. Conversely, the at least one autonomously driving vehicle is configured to drive into the intersection zone at a reduced speed or to stop if objects on the object list whose distance from the intersection zone is smaller than a distance threshold value have a confidence level that is smaller than a second threshold value. The first and the second threshold value can be identical or different.

This advantageous embodiment thus serves to safeguard intersections, in particular in an industrial environment. The danger lies in the fact that the paths of persons and autonomously driving vehicles can overlap at such intersections. Due to the limited visibility at such intersections, it is not always possible to assess the hazard situation in advance with the safety sensors attached to the autonomously driving vehicle. Consequently, an autonomously driving vehicle previously had to cross the intersection at creep speed. According to this embodiment, the associated restriction of the productivity can be avoided since sensor data are provided from other sources, with which sensor data it can be reliably determined whether a person is in the intersection zone or approaches it.

One possibility with which such a use case (intersection entry) can be implemented is shown below. By means of optical and/or radio-based localization sensors of the monitoring units, the positions of all relevant objects, such as persons and autonomously driving vehicles, in the zone to be monitored are detected and merged in a common real-time map. A real-time map can be understood as a joint entry of the detected objects in a spatial and temporal coordinate system. For example, 3D sensors with object tracking algorithms can be used here. In addition or as an alternative thereto, a UWB localization system with transponders on every person and every vehicle can also be used. The object information obtained in this way in the form of position data is merged in the central processing device (fusion module) and is, for example, checked for accuracy, consistency, confidence information and/or a priori knowledge and is enriched with a safety assessment, i.e. the confidence level, for each object. This “safe” object list forms the data foundation for the further use of all associated safety functions in the respective autonomously driving vehicles. In the case of the intersection monitoring, for example, different cases are distinguished and are treated differently in terms of safety. In the case of good and consistent measurement values, i.e., for example, if the position data of the optical systems and of the UWB system match within the framework of the tolerances, are consistent with the historical trajectories and were delivered with good confidence values, the safety function can use the following logic for hazard avoidance:
Decentralized safety systems at the autonomously driving vehicle are bypassed. In this case, the term “muting” is used.
If there is no person in the intersection zone, the autonomously driving vehicle can then cross the intersection without reducing the speed.
When a person approaches, a message can first be sent to the person not to enter the intersection for the time being (messaging via person tag). This message can be sent to the person via an optical and/or acoustic system, for example. If the person then stops approaching, the autonomously driving vehicle crosses the intersection at full speed. When the person approaches, the autonomously driving vehicle is reduced in its speed and, if necessary, is stopped until the person has left the intersection zone.

If there are objects in the relevant intersection environment whose safety level, i.e. confidence level, has been assessed as lower by the central processing device, a more cautious safeguarding logic is used:
The decentralized safety systems of the autonomously driving vehicle remain active and a reduced speed and a stop at the intersection are selected when approaching the intersection. The productivity is limited in this case, but an automatic operation is still possible.

If there is an error in the decentralized safety system of the autonomously driving vehicle, this would lead to an emergency stop of the autonomously driving vehicle in the familiar classic case. The automated operation can only be resumed once the error has been rectified by external measures. In the higher-ranking safety system assembly described here, the operation of the autonomously driving vehicle can be maintained by the redundant object information from the safe object list. As long as the object information generated here is of a sufficient quality and safety suitability (confidence level), the autonomously driving vehicle will continue to be operated. The error can be reported in the meantime and troubleshooting can be scheduled for a convenient time.

This safeguarding logic can be implemented in the form of a safety function cascade for the intersection hazard area. Similarly to the logic modules in a programmable safety controller, in this case, safety function modules are linked with the aid of case distinctions and, depending on the quality of the object information, are linked such that an optimal and robust operation becomes possible.

In a further embodiment, the at least one autonomously driving vehicle is configured to bypass or deactivate at least one or all of the safety systems, such as laser scanners, etc., of the autonomously driving vehicle in the event that a driving into the intersection zone without braking takes place. A triggering of the safety systems, which would lead to a braking or an emergency stop, does not occur in this case.

In a further embodiment, the at least one autonomously driving vehicle is configured to drive into a truck and/or a railroad car in order to unload or load goods, wherein the autonomously driving vehicle only drives into the truck and/or the railroad car if, in a distance range around the truck and/or the railroad car that is smaller than a distance threshold value, the objects on the object list are not persons and the corresponding object information of the objects has a confidence level that is greater than a threshold value, wherein the autonomously driving vehicle is configured to bypass or switch off one or all of the safety systems when driving into the truck and/or the railroad car. It is thereby ensured that the autonomously driving vehicle can pick up or unload goods even in the tightest of spaces without a braking or an emergency stop taking place. This further embodiment can also be designated as a higher-ranking vehicle safeguarding.

Further details on how this vehicle safeguarding can be realized are given below. It is assumed here that an autonomously driving vehicle is present in various operating zones of a factory or a warehouse. For example, it picks up a load directly at a transfer point in a truck, travels from there via a central route of the system to a separate warehouse and delivers the picked-up load to a robot, in particular in the form of a picking robot. Depending on the area and the situation, the safeguarding of the autonomously driving vehicle is designed very differently. The position data of the real-time map described above are used such that the optimal productivity is preferably achieved at all times, while considering the current position and environment of the autonomously driving vehicle.

If the autonomously driving vehicle is in the transfer region at the truck or the railroad car, the higher-ranking safety function of the autonomously driving vehicle recognizes, by means of the derived safe-point-of-interest function and the configured zones, that the safeguarding in this case, due to confined conditions and concealments, must take place without the on-board safety systems, such as the safety scanner. Only the available position information of the real-time map is used here. Specifically, the central processing device or the autonomously driving vehicle, which receives the object lists from the central processing device, monitors whether there are persons in the direct vicinity and in particular in the non-visible area of the truck or railroad car. In the event of absent or implausible position information, as well as errors, the autonomously driving vehicle is stopped. If valid position information is available and no approach has been detected, the autonomously driving vehicle can then drive into the truck or the railroad car and can pick up its load.

When transferring the load to the warehouse, the autonomously driving vehicle moves in zones with heavy traffic from persons and other (autonomously driving) vehicles. In this case, the safeguarding with the on-board safety systems, e.g. of the safety sensors, of the autonomously driving vehicle is necessary. They provide the primary safeguarding function in the zone and can be supplemented by position data of the real-time map, if necessary. An increase in the reliability of the evasion functions and an intersection monitoring, etc. are thereby achieved.

On arrival at the demarcated warehouse, the safety function can be switched back to the position-based environment monitoring based on the received object lists. In this example, it is assumed that the warehouse is fenced in or is demarcated by walls and that persons only enter it in the event of maintenance or a fault. When the autonomously driving vehicle enters through a lock, it is monitored based on the position data that no persons enter the autonomous area of the warehouse. The safety systems of the autonomously driving vehicle are then bypassed (muting) and the autonomously driving vehicle moves in the storage area of the warehouse without any potentially productivity-reducing safeguarding mechanisms.

In all these situations, a higher-ranking vehicle safety function obtains the position information of the objects in the environment of the autonomously driving vehicle from the central processing device via object lists. Depending on the positions and their plausibility and in particular on the confidence level, the type of safety function which is appropriate in this situation and with which the safety systems of the autonomously driving vehicle are operated, is selected and the selected function is executed based on the object information and the confidence level.

In a further embodiment, the at least one autonomously driving vehicle is configured, even in the event of a malfunction of at least one safety system that serves to monitor the environment, to continue travelling if the objects on the object list do not lead to a collision and the confidence level of these objects is greater than a threshold value.

The method according to the invention serves to monitor a zone, such as a warehouse or a factory, in which objects, such as autonomously driving vehicles and persons, move together. In a first method step, sensor data are received from a plurality of monitoring units, in which sensor data the objects detected in the monitored zone by the monitoring units are included. In a second method step, the received sensor data are consolidated. In a third method step, object lists are created from the consolidated sensor data, wherein the object lists include the detected objects together with the respective object information. In a fourth method step, these object lists are transmitted to the autonomously driving vehicles. In this respect, it is clear that the transmission of object lists to the autonomously driving vehicles also only includes the transmission of some of the object lists.

In a further embodiment, the autonomously driving vehicle is a forklift truck or the autonomously driving vehicles are forklift trucks.

In a further embodiment, the central processing device can also be described as a sensor fusion module and can act as the central interface of the safety system assembly.

In a further embodiment, the central processing device is configured to collect (to receive) sensor data from a plurality of monitoring units, to check said data for plausibility, to filter said data, to evaluate said data with respect to their information content (generating the object information and the confidence level) and to transmit said data to the autonomously driving vehicles in order to perform various safety functions.

In a further embodiment, the central processing device is configured to provide a user with information that an object with a confidence level below a threshold value is located in the vicinity of said user. This information can, for example, be communicated to the user as a radio message and/or optically, for example by a corresponding signaling device in the vicinity of the user. An acoustic message or a tactile message (for example via vibrations) is also conceivable.

In a further embodiment, the central processing device is configured to create an object with its object information from sensor data from different monitoring units. A much more precise description of the respective object is thereby possible. The confidence level is higher.

In a further embodiment, the at least one autonomously driving vehicle is configured to obtain, at regular time intervals, the object lists updated by the central processing device, in particular to download them from the central processing device. It is naturally also possible for the central processing device to send the updated object lists to the at least one autonomously driving vehicle at regular time intervals.

In a further embodiment, the transmission of the object lists from the central processing device to the at least one autonomously driving vehicle takes place via a wireless communication standard, such as WLAN.

In a further embodiment, the monitoring units are arranged, in particular mounted, exclusively or predominantly in the zone to be monitored.

In a further embodiment, at least two monitoring units are configured to generate monitoring fields that partly overlap.

In a further embodiment, a route runs through at least a part of the zone to be monitored, wherein the autonomously driving vehicles only move on the route, at least in a normal operating mode.

In a further embodiment, the monitoring units of the safety assembly are arranged such that at least 80% or at least 90% of the route is always covered by monitoring fields from at least two monitoring units.

In a further embodiment, the monitoring units are optical localization sensors and/or radio-based localization sensors.

In a further embodiment, the object list that is transmitted to the autonomously driving vehicle also comprises object information, such as the position, direction of movement and/or speed of movement, for precisely this autonomously driving vehicle.

In a further embodiment, the autonomously driving vehicle is configured to carry out a check of its own measurement values, such as the speed, position and/or direction of movement, based on at least one piece of object information which the autonomously driving vehicle receives about itself.

In a further embodiment, the autonomously driving vehicle is configured to transmit information to a higher-ranking control device, for example to the central processing device, in which information it is communicated that at least one of the measurement values of the autonomously driving vehicle does not match the received object information that describes the autonomously driving vehicle itself. In this case, maintenance can, for example, be scheduled and the autonomously driving vehicle can be removed from the productive operation.

In a further embodiment, the monitoring units are cameras or camera sensors, radar sensors, 3D scanners, radio-based tracking systems, contact loops in the floor and/or locking devices.

The invention will be described purely by way of example with reference to the drawings in the following. There are shown:

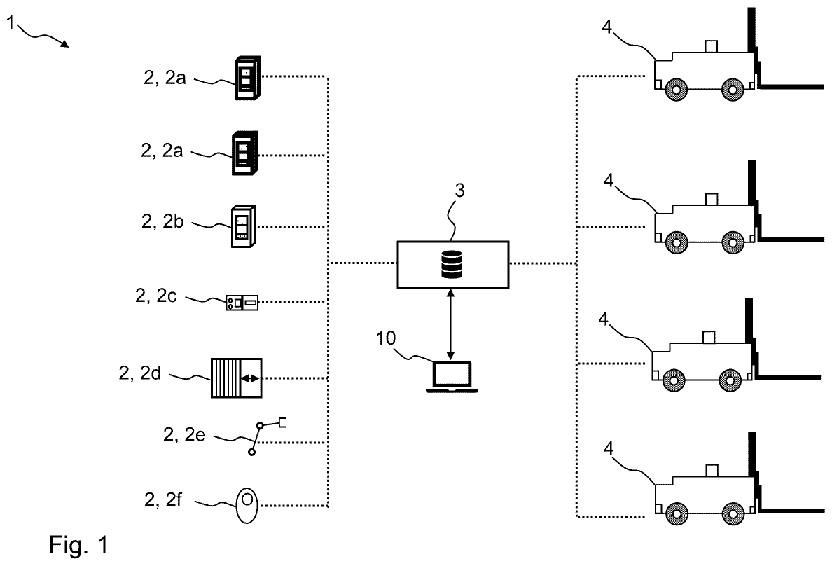

FIG. 1: an embodiment example of the safety system assembly according to the invention that comprises a plurality of monitoring units, a central processing device and autonomously driving vehicles;

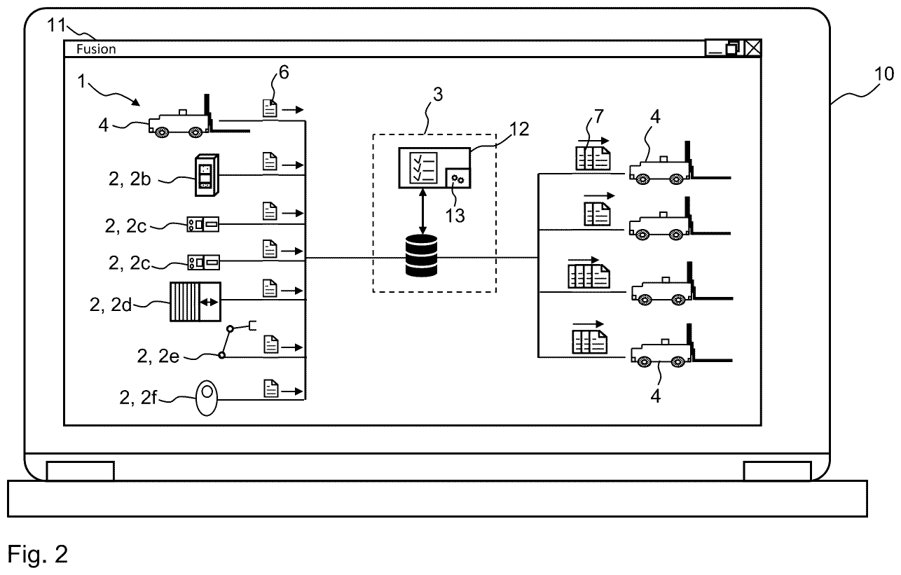

FIG. 2: shows a visualization of the safety system assembly, from which it can be seen how various data are transmitted within the safety system assembly;

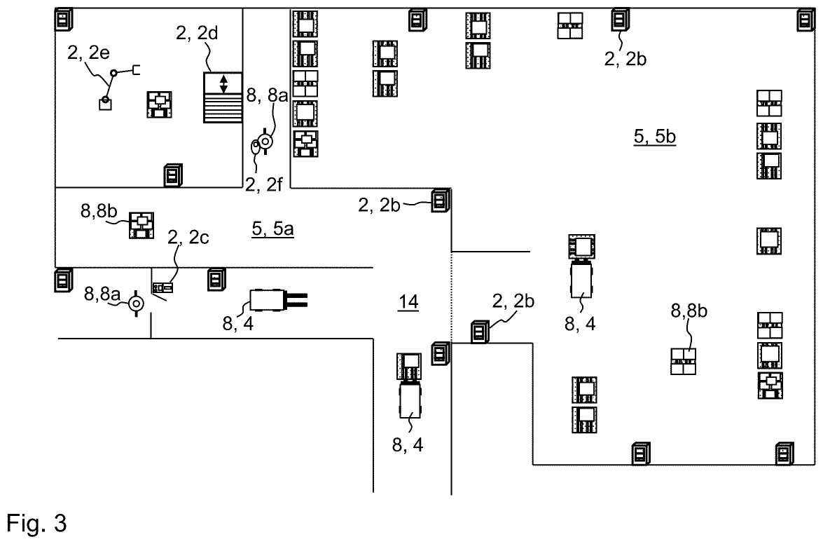

FIG. 3: shows a real-time map of the zone to be monitored, in which real-time map the corresponding detected objects are drawn by the central processing device, wherein the more efficient crossing of an intersection is described;

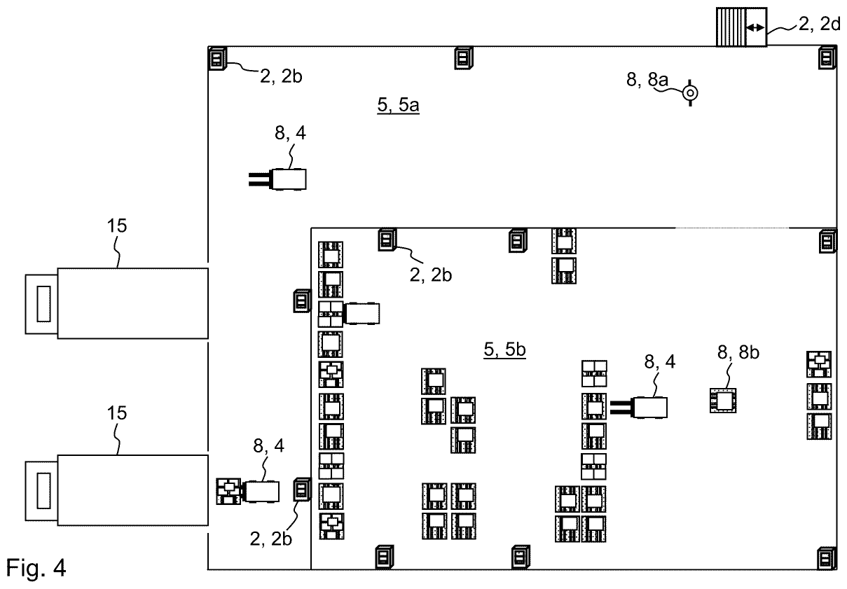

FIG. 4: shows a real-time map of the zone to be monitored, in which real-time map the corresponding detected objects are drawn by the central processing device, wherein the more efficient unloading or loading of a truck is a described; and

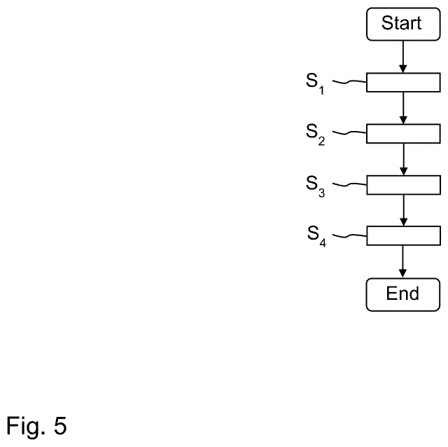

FIG. 5: a method of monitoring a zone such as a warehouse or a factory.

FIG. 1 shows an embodiment example of the safety system assembly 1 according to the invention that comprises a plurality of monitoring units 2, a central processing device 3 and autonomously driving vehicles 4. The safety system assembly 1 serves to monitor a zone 5, such as a warehouse or a factory. The plurality of monitoring units 2 are configured to monitor a specific part of the zone in each case and to generate corresponding sensor data 6. The monitoring units 2 are configured to transmit the sensor data 6 to the central processing device 3. The central processing device 3 is configured to consolidate the received sensor data 6. In this respect, the central processing device 3 creates object lists 7 from the consolidated sensor data, wherein the object lists include the detected objects 8. These objects 8 can be persons 8a, autonomously driving vehicles 4 and stationary objects such as pallets 8b. For each object, there is corresponding object information that is likewise the content of the object list 7. Object information can be the position, size, direction of movement and/or speed of movement, object ID and/or object class of the object. The corresponding object lists 7 are then transmitted to the autonomously driving vehicles 4.

The monitoring units 2 can be different devices that are configured to generate sensor data 6 in which the objects 8 are included. In FIG. 1, the monitoring units 2 are cameras 2a, radar sensors 2b, locking devices 2c, door systems 2d, robots 2e and radio-based tracking systems 2f that are, for example, attached to persons and/or vehicles.

The sensor data 6 can be raw data generated by the respective monitoring units 2. It is also possible that the monitoring units 2 already prepare the sensor data 6 so that the central processing device 3 can process these data more easily. The sensor data 6 can be available in different forms. If the monitoring unit 2 is a camera 2a, the camera image can be transmitted directly in the form of sensor data 6 to the central processing device 3. It is also conceivable that the camera 2a detects the object 8 in the image itself and only transmits the position of the object 8 in the image or in the monitored zone 5 in the form of coordinates to the central processing device 3. The same can also apply if the monitoring unit 2 is a radar sensor 2b. If the monitoring unit 2 is a locking device 2c, the actuation of the locking device 2c can be detected and can be transmitted in the form of sensor data to the central processing device 3. The central processing device 3 then knows that a person 8a or an autonomously driving vehicle 4 is exiting or entering the door area that is safeguarded by the locking device 2c. The same also applies in the event that the monitoring unit 2 is an (automatic) door system 2d. If the corresponding door leaf opens and closes, this can be seen as an indicator that a person 8a or an autonomously driving vehicle 4 is entering or leaving the door area. If the monitoring unit 2 is a machine, such as a robot 2e, the corresponding sensor data 6 that are transmitted by this machine to the central processing device 3 can reflect the state of this machine. If a cycle or work sequence of the machine takes place, this information can be viewed as an indication that, for example, a person 8a or an autonomously driving vehicle 4 will soon arrive to collect the manufactured goods or to deliver materials to be processed. The monitoring unit 2 can also be a radio-based tracking system 2f that is, for example, attached to vehicles or persons 8a in order to reliably detect their position in the zone 5 to be monitored. The monitoring unit 2 can also be an autonomously driving vehicle 4 that has corresponding sensors, such as LIDAR sensors, to thus scan the environment.

The individual monitoring units 2 can be connected to the central processing device 3 via a cable connection or wirelessly.

The central processing device 3 can, for example, be a central computer system that is arranged in a central or decentralized manner (for example in the cloud).

The central processing device 3 is configured to convert the sensor data 6 of the plurality of monitoring units 2 into a common spatial and temporal coordinate system 9. Such a common coordinate system 9, in the form of a real-time map, is shown in FIGS. 3 and 4.

The common coordinate system 9 can also be displayed on an operator terminal that is connected to the central processing device 3. Via the operator terminal 10, control commands can also be transmitted to the central processing device 3 and further preferably to the monitoring units 2 and/or autonomously driving vehicles 4 that are connected to the central processing device 3.

FIG. 2 shows a visualization of the safety system assembly 1, from which it can be seen how various data are transmitted within the safety system assembly 1. In this case, the visualization takes place on the operator terminal 10. An application 11 is started on the operator terminal 10 to control the central processing device 3. The sensor data 6 are transmitted from the individual monitoring units 2 to the central processing device 3. The sensor data 6 are consolidated there, wherein the central processing device 3 is configured to detect the individual objects 8 in the sensor data 6 or the consolidated sensor data and to create corresponding object lists 7. The object lists 7 comprise the respective objects 8 together with their object information. The object lists 7 are then transmitted to the autonomously driving vehicles 4. Not every autonomously driving vehicle 4 must receive the same object lists 7. An object list 7 includes at least one object 8 with at least one piece of object information for this object 8.

The central processing device 3 is preferably also configured to subject the received sensor data 6 to a plausibility check. If the monitoring zones from at least two monitoring units 2 overlap, an object 8 must thus be detected in both sensor data 6. Otherwise, the sensor data 6 are not plausible. Nothing else then applies even if the monitoring zones of two monitoring units 2 adjoin one another. If an object 8 moves successively through both monitoring zones, this object 8 must be visible in both sensor data 6 of the monitoring units 2, albeit with a time delay.

In FIG. 2, it is also shown that the safety system assembly 1 comprises an assessment device 12. In this case, the assessment device 12 is part of the central processing device 3. The assessment device 12 is configured to determine a confidence level for an object 8 based on the sensor data 6 and/or the object information. The assessment device 12 is configured to define a higher confidence level for an object 8 if the object 8 is included in sensor data 6 from at least two monitoring units 2 that were produced at the same time and whose monitoring fields at least partly overlap, or if the object 8 appears with a time delay in sensor data 6 from different monitoring units 2 whose monitoring fields are arranged next to one another.

In FIG. 2, it is furthermore shown that the assessment device 12 comprises an AI module 13. The AI module 13 is configured to determine the confidence level for an object 8 based on the sensor data 6 and/or the object information. The central processing device 3 is configured to add the confidence level to the object list for the corresponding object 8 or to add this confidence level directly to the object information for the object 8. The autonomously driving vehicle 4 is then configured, depending on the objects 8 on the object list and their confidence level in different situations, to react adapted to the confidence level.

FIG. 3 shows a real-time map of the zone 5 to be monitored, in which real-time map the corresponding detected objects 8 are drawn by the central processing device 3. A specific confidence level is preferably determined for each object 8. The zone 5 comprises a normal zone 5a and a closed-off zone 5b. Both zones 5a, 5b are separated from one another by a dotted line. In the normal zone 5a, autonomously driving vehicles 4 and persons 8a are simultaneously present during normal operation. In the closed-off zone 5b, only autonomously driving vehicles 4 were present during normal operation. In both the normal zone 5a and the closed-off zone 5b, there are a plurality of monitoring units 2. The autonomously driving vehicles 4 are configured to deactivate (de-energize, mute, etc.) their safety systems, such as a laser scanner, in the closed-off zone 5b and to rely solely on the object information of the object lists 7 that are transmitted to the autonomously driving vehicles 4 via the central processing device 3. Pallets 8b can thereby be arranged particularly close together since the safety systems of the autonomously driving vehicles 4 do not trigger an emergency release. In the normal zone 5a, however, the safety systems are preferably activated. An intersection zone 14 is furthermore shown in the normal zone 5a. The intersection zone 14 and the environment of the intersection zone 14 are monitored by corresponding monitoring units 2. The autonomously driving vehicle 4, which drives into the intersection zone 14 from below in FIG. 2, has received an object list 7 comprising relevant objects 8 in the intersection zone 14 (objects within a specific distance from the intersection zone 14). The confidence level of the objects 8 in the intersection zone 14 is greater than a threshold value so that the autonomously driving vehicle 4 coming from below can reliably determine that the intersection zone 14 is free of other objects 8. The autonomously driving vehicle 4 coming from below is therefore configured to drive into the intersection zone 14 without reducing the speed and, optionally, even to deactivate its safety systems. In the event that the confidence level is below a threshold value (e.g. a different threshold value), the autonomously driving vehicle 4 coming from below would drive into the intersection zone 14 at a reduced speed or even stop before entering.

FIG. 4 shows a further real-time map of a zone 5 to be monitored, in which real-time map the corresponding detected objects 8 are drawn by the central processing device 3. In this embodiment example, it is explained how autonomously driving vehicles 4 can unload or load a truck 15 more efficiently. The autonomously driving vehicles 4 have in turn received an object list 7, which includes a plurality of objects 8 together with the corresponding object information, from the central processing device 3. A confidence level is again formed for each object 8. The zone 5 to be monitored again comprises a normal zone 5a and a closed-off zone 5b. Furthermore, the zone 5 to be monitored is monitored by a plurality of monitoring units 2. At least one of these monitoring units 2 is arranged such that it can see into a truck 15 to be unloaded. The corresponding sensor data 6 of this at least one monitoring unit 2 can then include objects 8 that are located in the truck 15 to be unloaded or loaded and/or directly in its vicinity. These objects 8 can in turn be added to an object list 7 by the central processing device 3. A corresponding confidence level can likewise be formed for these objects 8 (e.g. based on the quality with which the corresponding monitoring unit works) and can likewise be added to the object list 7. The autonomously driving vehicle 4 receives this object list 7 and is configured to drive into the truck 15 if the object list 7 provides the information that there are no persons 8a within a specific distance threshold value from the truck 15 and the confidence level for the detected objects 8 is greater than a threshold value. In this case, the autonomously driving vehicle 4 is configured to drive into the truck 15 and to bypass or switch off one or all of its safety systems, such as a laser scanner, in the process. As a result, an emergency triggering of the safety systems of the autonomously driving vehicle 4 due to the limited space conditions inside the truck 15 does not take place.

The central processing device 3 is also configured to send an object list 7 to a mobile end device, such as a smartphone, of a person 8a. The person 8a then has real-time data with respect to the current position of the respective objects 8 in the zone 5 to be monitored.

FIG. 5 describes a method of monitoring a zone 5, such as a warehouse or a factory. In a first method step S₁, sensor data 6 are received from a plurality of monitoring units 2, in which sensor data the objects 8 detected by the monitoring units 2 in the monitored zone 5 are included. In a second method step S₂, the received sensor data 6 are consolidated. In a third method step S₃, object lists 7 are created from the consolidated sensor data, wherein the object lists 7 include the detected objects 8 together with the respective object information. In a fourth method step S₄, these object lists are transmitted to the autonomously driving vehicles 4.

The invention is not restricted to the embodiment examples described. Within the scope of the invention, all the described and/or drawn features can be combined with one another in any desired manner.

### REFERENCE NUMERAL LIST

safety system assembly 1
monitoring unit 2
camera 2a
radar sensor 2b
locking device 2c
door system 2d
robot 2e
radio-based tracking system 2f
central processing device 3
autonomously driving vehicles 4
zone 5
normal zone 5a
closed-off zone 5b
sensor data 6
object lists 7
objects 8
persons 8a
pallets 8b
coordinate system 9
operator terminal 10
application 11
assessment device 12
AI module 13
intersection zone 14
truck 15
method steps S₁, S₂, S₃, S₄

1. A safety system assembly for monitoring a zone in which objects move together,
wherein the safety system assembly comprises a central processing device that is configured to receive sensor data from a plurality of monitoring units, in which sensor data the objects detected in the monitored zone by the monitoring units are included,
wherein the central processing device is configured to consolidate the received sensor data,
wherein the central processing device is configured to create object lists from the consolidated sensor data, with the object lists including the detected objects together with the respective object information, and to transmit these object lists to the autonomously driving vehicles.

2. The safety system assembly according to claim 1, wherein the zone is one of a warehouse and a factory.

3. The safety system assembly according to claim 1, wherein the objects are at least one of autonomously driving vehicles and persons.

4. The safety system assembly according to claim 1,
wherein the object information of an object comprises a position, size, direction of movement and/or speed of movement, object ID and/or object class for the object.

5. The safety system assembly according to claim 1,
wherein the central processing device is configured to convert the sensor data of the plurality of monitoring units into a common spatial and temporal coordinate system.

6. The safety system assembly according to claim 1, wherein the central processing device is configured to subject the received sensor data to a plausibility check by checking whether:
a) a respective object is included in the sensor data from at least two monitoring units whose monitoring zones at least partly overlap; and/or
b) a respective moving object is included, in different but mutually adjoining time periods, in the sensor data from at least two monitoring units whose monitoring zones adjoin one another.

7. The safety system assembly according to claim 1,
wherein the safety system assembly comprises an assessment device that is configured to determine a confidence level for an object based on the sensor data and/or the object information.

8. The safety system assembly according to claim 7,
wherein the assessment device is configured to define a higher confidence level for an object if the object is included in sensor data from at least two monitoring units that were produced at the same time and whose monitoring fields at least partly overlap.

9. The safety system assembly according to claim 7,
wherein the assessment device is configured to determine the confidence level for the object based on the quality of the sensor data and/or of the object information.

10. The safety system assembly according to claim 9,
wherein the quality of the:
a) sensor data depends on physical properties of the respective monitoring unit;
and/or
b) object information depends on the position, direction of movement and/or object class.

11. The safety system assembly according to claim 10, wherein the physical properties comprise the age, the type, the error rate, the failure rate, the scatter rate, the measurement method, the installation location and/or confidence information of the respective monitoring unit.

12. The safety system assembly according to claim 10, wherein the object information depends on whether it is a person or an autonomously driving vehicle.

13. The safety system assembly according to claim 7,
wherein the assessment device comprises an AI module and wherein the AI module is configured to determine the confidence level for an object based on the sensor data and/or the object information.

14. The safety system assembly according to claim 7,
wherein the safety system assembly comprises at least one autonomously driving vehicle, wherein the at least one autonomously driving vehicle is configured to receive the object list from the central processing device.

15. The safety system assembly according to claim 14,
wherein the at least one autonomously driving vehicle is configured to:
a) drive into an intersection zone without braking if objects on the object list whose distance from the intersection zone is smaller than a distance threshold value have a confidence level that is greater than the first threshold value; and
b) to drive into the intersection zone at a reduced speed or to stop if objects on the object list whose distance from the intersection zone is smaller than a distance threshold value have a confidence level that is smaller than a second threshold value.

16. The safety system assembly according to claim 15,
wherein the at least one autonomously driving vehicle is configured to bypass or deactivate at least one or all of the safety systems of the autonomously driving vehicle in the event that a driving into the intersection zone without braking takes place.

17. The safety system assembly according to claim 14,
wherein the at least one autonomously driving vehicle is configured to drive into a truck and/or a railroad car in order to unload or load goods, wherein the autonomously driving vehicle only drives into the truck and/or the railroad car if, in a distance range around the truck and/or the railroad car that is smaller than a distance threshold value, the objects on the object list:
a) are not persons;
b) the corresponding object information of the objects has a confidence level that is greater than a threshold value;
wherein the autonomously driving vehicle is configured to bypass or switch off one or all of the safety systems when driving into the truck and/or the railroad car.

18. The safety system assembly according to claim 14,
wherein the at least one autonomously driving vehicle is configured, even in the event of a malfunction of at least one safety system that serves to monitor the environment, to continue travelling if the objects on the object list do not lead to a collision and the confidence level of these objects is greater than a threshold value.

19. A method of monitoring a zone, in which objects move together, comprising the following method steps:
receiving sensor data from a plurality of monitoring units, in which sensor data the objects detected in the monitored zone by the monitoring units are included;
consolidating the received sensor data;
creating object lists from the consolidated sensor data, wherein the object lists include the detected objects together with the respective object information;
transmitting these object lists to the autonomously driving vehicles.
